(19) United States
(12) Patent Application Publication
(10) Pub. No.: US 2009/0050455 A1
(43) Pub. Date: Feb. 26, 2009

(54) Electrical Circuit Breaker

(75) Inventor: Peter Meckler, Hohenstadt/Pommelsbrunn (DE)

Correspondence Address: LERNER GREENBERG STEMER LLP, P O BOX 2480, HOLLYWOOD, FL, 33022-2480, US

(73) Assignee: ELLENBERGER & POENSGEN GMBH, Altdorf (DE)

(21) Appl. No.: 12/260,105

(22) Filed: Oct. 29, 2008

Related U.S. Application Data
(63) Continuation of application No. PCT/EP2007/004047, filed on Apr. 29, 2006.

(51) Int. Cl. H01H 3/12

(52) U.S. Cl. 200/314; 200/341

(57) ABSTRACT

In order to increase an ease of operation of a circuit breaker it is provided that, as an operating device for manual actuation of a switching element of the circuit breaker, a touch-sensitive control board is integrated in a housing of the circuit breaker. The touch-sensitive control board provides improved operator control convenience.

### CROSS-REFERENCE TO RELATED APPLICATION

This is a continuing application, under 35 U.S.C. § 120, of copending international application No. PCT/EP2006/004047, filed Apr. 29, 2006, which designated the United States; the prior application is herewith incorporated by reference in its entirety.

### BACKGROUND OF THE INVENTION

### Field of the Invention

The invention relates to an electrical circuit breaker, in particular an overcurrent circuit breaker, for interrupting an electrical circuit, in which a tripping mechanism with a switching element is disposed in a housing in order to disconnect a supply line, and with an operator control element being provided in order to manually operate the switching element.

A circuit breaker of this type is disclosed, for example, in published, European patent application EP 0 973 239 A2. Circuit breakers of this type are generally used to protect the lines of an electrical load circuit and a load, which is arranged in the circuit in a switchable manner, against short circuits or overloads. To this end, the electrical load circuit is connected to the external conductor of a supply or operating voltage via the circuit breaker which disconnects the electrical load or control circuits in the event of a fault. After the circuit breaker is tripped in the event of a fault, the circuit breaker can be manually reset by the operator control element which can be operated from the outside, so that the electrical load circuit is again connected to the external conductor of the supply or operating voltage. The manually operated operator control element is usually a rocker switch or a momentary-contact switch.

### SUMMARY OF THE INVENTION

It is accordingly an object of the invention to provide an electrical circuit breaker that overcomes the above-mentioned disadvantages of the prior art devices of this general type, which has improved operator control convenience.

According to the invention, provision is made for an operator control element to be in the form of a touch-sensitive operator control panel which is integrated in the housing of the circuit breaker. The operator control panel, which is also designated a “touch panel” or a “touch screen”, is therefore a constituent part of the circuit breaker. A touch-sensitive operator control panel is understood to be an operator control unit in which a switching element is electronically displayed on a touch screen or sensor monitor, with an operator control command being generated when the screen is touched in the region of the displayed switching element. In this case, the operator control panel does not have any moving switching element parts.

The use of a touch panel of this kind first increases operator convenience since, for example, it is only necessary to touch the contact panel in order to reset the circuit breaker after it has been tripped in the event of a fault. At the same time, the integration of the operator control panel in the circuit breaker permits an increase in the functional scope. In particular, it is possible to use the operator control panel to provide a multifunctional operator control menu, so that the operator control element which is in the form of an operator control panel can be multifunctional overall. Finally, the mechanical construction is simpler and the susceptibility to mechanical faults is lower than in the case of a mechanical toggle switch or momentary-contact switch.

According to an expedient development, the operator control panel is simultaneously in the form of a display element for displaying up-to-date status information about the circuit breaker. In particular, the operator control panel therefore displays whether the circuit breaker has tripped following a fault and is in the “off” position, or whether it is in the normal operating position “on”. On account of the multifunctionality of the operator control panel which functions as a display element, an extremely wide variety of information can also be displayed here or be displayed such that it can be called up by a menu.

In order to provide simple accessibility, the operator control panel is, according to an expedient refinement, integrated in the front face of the housing and forms, in particular, a large part of the front face, in order to provide the largest possible surface area for the operator control panel.

The operator control panel is preferably connected to a control device which is configured to emit a control signal, with the control signal resulting in operation of the switching element as a function of operation of the operator control panel. The control device therefore converts the operator control commands input via the touch panel into corresponding control commands or control signals. At the same time, the control device also controls the information displayed on the operator control panel, for example status information about the state of the circuit breaker. In this case, the control device is also preferably provided with a memory which contains information, for example about existing configuration states of the circuit breaker or else about the history, for example information about when the circuit breaker has tripped etc. This information can preferably be read out or displayed on the operator control panel and can therefore be used following a fault for fault diagnosis, for example for evaluating when the fault occurred.

According to an expedient development, the circuit breaker can also be configured by the operator control panel. For example, tripping threshold values are set by the operator control panel.

According to a preferred refinement, the switching element is an electronic switching element, such as intelligent power semiconductors or semiconductor switching elements such as FET or MOS components. In this case, the operator control panel is connected to the switching element via the control device in order to operate the switching element. Integration of the touch panel in an electronic circuit breaker with an electronic switching element of this type is particularly advantageous since electrical control signals which are generated directly in a simple manner by the control device are sufficient for operation of the switching element.

As an alternative to this configuration with the electronic switching element, the switching element has a mechanically operated switching member, with an actuator which is activated with the aid of the control signals being provided for operating the switching member. An actuator of this type is, for example, an electromotive drive with which the mechanical switching member can be moved to the normal operating position “on”. A magnetic actuator can also be provided as an alternative to an electromotive drive.

Other features which are considered as characteristic for the invention are set forth in the appended claims.

Although the invention is illustrated and described herein as embodied in an electrical circuit breaker, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, highly simplified block diagram of an electronic circuit breaker with a touch-sensitive operator control panel according to the invention; and

FIG. 2 is a diagrammatic, highly simplified block diagram, of a mechanical circuit breaker with a touch-sensitive operator control panel.

### DETAILED DESCRIPTION OF THE INVENTION

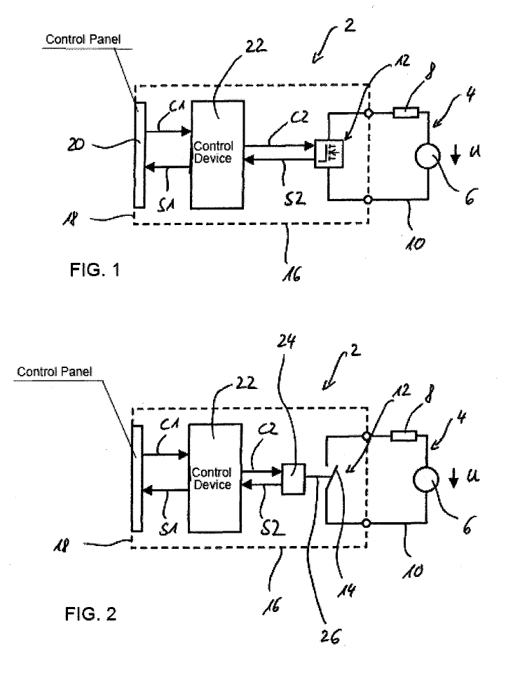

In the figures, identically acting parts are provided with the same reference symbols. Referring now to the figures of the drawing in detail and first, particularly, to FIG. 1 thereof, there is shown a circuit breaker 2, which is only sketched in a highly simplified manner in the figures, is connected in a load circuit 4. The load circuit 4 contains a voltage source 6 for providing an operating voltage U, and a load 8, for example a machine in a production line, a motor or any other electrical load. The load 8 is connected to the operating voltage via a line 10. In the exemplary embodiment, only a single-pole connection of the load 8 to the voltage source 6 is illustrated. In principle, the load 8 can also be connected to the voltage source 6 via multiple poles. In the case of multipole supply, each strand of the line 10 is usually monitored by a circuit breaker 2 or a circuit breaker device in each case.

The circuit breaker 2 protects the line 10 and the load 8 against an overload current or against a short circuit current. In this case, the circuit breaker 2 can be configured, in principle, for an extremely wide variety of rated voltages and rated currents.

The circuit breaker has an overcurrent protection circuit (not illustrated in any detail here) in order to exercise overcurrent protection.

If the prespecified rated current is exceeded, a switching element 12 of the circuit breaker disconnects the load 8 from the load circuit 4. In the case of the circuit breaker 2 which is illustrated in FIG. 1, the switching element 12 is configured as an electronic switching element, for example as a power semiconductor, an FET or MOS semiconductor component or the like. In the exemplary embodiment of FIG. 2, the switching element 12 contains a mechanically operated switching member 14. The switching member 14 is configured as a thermal, thermal- magnetic or similar circuit breaker. A pure switching contact is also possible when the current is detected and a tripping signal for operating the switching member 14 is generated by a control device 22.

The circuit breaker 2 has a housing 16 which is illustrated using dashed lines in the figures. A touch-sensitive operator control panel 20, also designated a touch panel in general, is integrated in a front face 18 of the housing 16. The operator control panel 20 is connected to the control device 22. The control device 22 is in turn connected to the electronic switching element 12 in the exemplary embodiment of FIG. 1, and to an actuator 24 in the exemplary embodiment of FIG. 2. The actuator 24 acts on the switching member 14 via an actuating member 26.

During operation, status signals S1 are transmitted from the control device 22 to the operator control panel 20. Control signals C1 are transmitted in the opposite direction from the operator control panel 20 to the control device 22. The control device 22 forwards control signals C2 to the electronic switching element 12 or to the actuator 24 as a function of the control signal C1. The electronic switching element and actuator in turn transmit status signals S2 to the control device 22.

During operation, the circuit breaker 2 monitors the load circuit 8 for an overcurrent. The current state of the switching element 12 is transmitted as a status signal S2 to the control device 22 and from here as a status signal S1 on to the operator control panel 20 which is simultaneously configured as a display element and displays the current state.

If an overcurrent is detected, the circuit breaker 2 trips and the switching element 12 disconnects the load 8 from the load circuit 4, as is illustrated, for example, in FIG. 2. The changed state is displayed on the operator control panel 20. As soon as the fault which causes the overcurrent is again rectified, the switching element 12 has to be moved back to the usual operating position. This is done by manual operation by a touch-sensitive surface area of the operator control panel 20 being operated by contact and the control signal C1 being produced. The control signal is converted into the control signal C2 in the control device 22, with the result that the switching element 12 is switched to the home position. In the case of the electronic switching element 12, switching is performed directly by the control signal C2, which is therefore a control signal for directly activating the electronic component. In the exemplary embodiment of FIG. 2, the control signal C2 activates the actuator 24 and, via this, indirectly the actuating member 26.

The operator control panel 20 preferably covers the entire surface area, or virtually the entire surface area, of the front face 18, in order to provide the largest possible operator control or display area. When a plurality of circuit breakers 2, which are arranged, for example, on a top-hat rail next to one another and which are in each case provided for switching one core of a multi-pole line, are mechanically or electronically coupled, only one operator control panel is preferably provided for the plurality of circuit breakers 2. The respective switching elements 12 of the plurality of circuit breakers 2 are operated jointly by the operator control panel 20. The status information is also jointly displayed on the operator control panel 20.

The integration of the operator control panel 20 in the housing 16 in conjunction with the control device 22 provides a clear usage value to the user. In addition to the conventional mechanical operator control elements, for example rocker switches, the use of the operator control panel 20 provides the specific option of integrating a plurality of functions. In particular, the display functionality which informs the user in particular about the current state of the circuit breaker 2 should be emphasized here. The ability to vary the operator control panel 20 is particularly advantageous. In principle, the control device 20 specifically provides a largely free ability to control the operator control panel 22. It is therefore possible to both display complex information and also permit complex operator control inputs. Therefore, for example in the case of the electronic circuit breaker 2 according to FIG. 2, it is possible to configure and set the circuit breaker 2 by the operator control panel 20. Therefore, the rated currents at which the circuit breaker 2 should trip can preferably be selected by the operator control panel 20. In preferred further variants, information about the state of the circuit breaker 2 is additionally at least temporarily stored, in order to be able to be called up, for example, for diagnosis purposes. For example, the control device 22 contains a memory in which information about when the circuit breaker 2 was tripped is stored.

Overall, integration of the operator control panel 20 in the housing 16 therefore provides greater operator control convenience together with a high usage value.

Integration of the operator control panel 20 has been explained in relation to FIGS. 1 and 2 using an overcurrent circuit breaker by way of example. In the same way, the operator control panel 20 can also be integrated in other types of circuit breakers, for example fault current circuit breakers.

1. An electrical circuit breaker for interrupting an electrical circuit, the electric circuit breaker comprising:
a housing;
a tripping mechanism having a switching element disposed in said housing for disconnecting a supply line; and
an operator control element for manually operating said switching element, said operator control element being a touch-sensitive operator control panel integrated in said housing.

2. The electrical circuit breaker according to claim 1, wherein said touch-sensitive operator control panel is simultaneously a display element for displaying up-to-date status information.

3. The electrical circuit breaker according to claim 1, wherein said housing has a front face and said touch-sensitive operator control panel is integrated in said front face.

4. The electrical circuit breaker according to claim 1, further comprising a control device configured for emitting a control signal for operating said switching element in dependence on an operation of said touch-sensitive operator control panel, said touch-sensitive operator control panel being connected to said control device.

5. The electrical circuit breaker according to claim 1, wherein the circuit breaker can be configured by said touch-sensitive operator control panel.

6. The electrical circuit breaker according to claim 1, wherein said switching element is an electronic switching element and is connected to said touch-sensitive operator control panel for transmitting a control signal.

7. The electrical circuit breaker according to claim 1, wherein said switching element has a mechanically operated switching member and an actuator, said actuator can be activated by said touch-sensitive operator control panel and is provided for operating said switching member.

8. The electrical circuit breaker according to claim 1, wherein the electrical circuit breaker is an overcurrent circuit breaker.
